(19) United States
(12) Patent Application Publication
(10) Pub. No.: US 2005/0265340 A1
(43) Pub. Date: Dec. 1, 2005

(54) Network address-port translation apparatus and method

(76) Inventors: Hung-Yu Wu, Gueishan Township (TW); Jin-Ru Chen, Taichung City (TW); Chun-Feng Liu, Taipei City (TW)

Correspondence Address: Raymond Sun, 12420 Woodhall Way, Tustin, CA, 92782, US

(21) Appl. No.: 11/142,642

(22) Filed: Jun. 1, 2005

(30) Foreign Application Priority Data
Jun. 1, 2004 (TW) 093115590

(51) Int. Cl. H04L 12/56

(52) U.S. Cl. 370/389

(57) ABSTRACT

A network address-port translation (NAPT) method includes: selecting a set of server IP and port from the server port table according to an external-to-internal packet; performing NAPT of the external-to-internal packet according to the selected set of server IP and server port; selecting a storage element from the translation table according to an internal-to-external packet; and performing NAPT of the internal-to-external packet according to the selected storage element.

### BACKGROUND OF THE INVENTION

(a). Field of the Invention

The present invention relates in general to the field of network system, and more particularly to the field of network address-port translation (NAPT).

(b). Description of the Prior Arts

The Internet transceives data by TCP/IP protocols that adopt IP addressing system, which renders a unique IP address to each network node on the Internet to facilitate data transmission. To solve the IP inadequacy problem, Network Address Translation (NAT) and Network Address-Port Translation (NAPT) are developed.

If a node with a private IP needs to access external networks (e.g. the Internet), a NAT/NAPT-enabled equipment, such as a router, is needed, as shown in FIG. 1. The conventional NAT/NAPT-enabled equipment uses a built-in CPU to run associated software for NAT/NAPT, i.e., the NAT/NAPT function is implemented by software and indirectly performed. A public IP is a normal IP used in various networks which apply TCP/IP protocols, while a private IP is only used in an internal network, such as the local area network (LAN) of an institution or family. That is, the private IP cannot be used to connect directly to external networks.

In NAT, because of one-to-one correspondence between public and private IPs, N public IPs can only serve for N private IPs. In NAPT, correspondence between private and public IPs is not one-to-one, so more computers can connect to the Internet simultaneously by using different combinations of public IPs and associated ports.

In this specification, a “NAPT connection” means a network connection whose packets need NAPT, an “internal-to-external packet” means a packet transmitted from an internal network to an external network, and an “external-to-internal packet” means a packet transmitted from an external network to an internal network.

If each opened server port, such as the ports of a web server for outside access, only corresponds to a set of external IP and external port, only a server port table is needed to perform NAPT for an associated NAPT connection. The server port table records the correspondence between each set of server IP and port and a set of external IP and port. For a NAPT connection between the external network and an internal server port, only a corresponding set of IP and port would be found in the server port table when performing NAPT of an internal-to-external packet or external-to-internal packet.

If two available external IPs (denoted as IPₑₓₜ₁ and IPₑₓₜ₂) are obtained from two different Internet service providers (ISPs), and the user wants that a opened set of server IP and server port (denoted as IPᵢₙₜ and Portᵢₙₜ) can be serviced simultaneously by these two ISPs, that is, {IPᵢₙₜ, Portᵢₙₜ} is corresponding to both {IPₑₓₜ₁, Portₑₓₜ₁} and {IPext2, POrtext2}, then the correspondence {IPᵢₙₜ, Portᵢₙₜ, IPₑₓₜ₁, Portₑₓₜ₁} and {IPᵢₙₜ, Portᵢₙₜ, IPₑₓₜ₁, Portₑₓₜ₁} will be both recorded in the server port table. For a NAPT connection between the external network and {IPᵢₙₜ, Portᵢₙₜ}, only a corresponding set of IP and port (i.e. {IPᵢₙₜ, Portᵢₙₜ}) will be found for an external-to-internal packet of the NAPT connection, and NAPT of the external-to-internal packet is performed therewith. However, two corresponding sets of IP and port (i.e. {IPₑₓₜ₁, Portₑₓₜ₁} and {IPₑₓₜ₂, Portₑₓₜ₂}) will be found for an internal-to-external packet of the NAPT connection. If there is not a proper mechanism for selecting the correct set of IP and port, NAPT of the internal-to-external packet will fail. For example, if some computer in the external network connects to {IPᵢₙₜ, Portᵢₙₜ} via {IPₑₓₜ₁, Portₑₓₜ₁} and the internal network selects {IPₑₓₜ₂, Portₑₓₜ₂} to reply with, then a wrong translation will be performed and the associated NAPT connection can not be established or maintained.

### SUMMARY OF THE INVENTION

In view of this, an object of the present invention is to provide a NAPT apparatus and method which can perform NAPT for a connection between an external network and an opened set of server IP and port of an internal network. The NAPT function is implemented in the hardware of the NAPT apparatus and directly performed.

Accordingly, the NAPT apparatus of the present invention comprises: a server port table for storing at least a set of server IP and server port of an internal network and at least a corresponding set of external IP and external port; a translation table comprising a plurality of storage elements, wherein each of the storage elements at least stores a set of external IP and external port; and a packet translation module, coupled to the server port table and the translation table, for performing NAPT for a connection between an external network and the set of server IP and server port of the internal network.

In another aspect, the NAPT method of the present invention is performed by means of a server port table and a translation table. The NAPT method comprises: selecting a corresponding set of server IP and server port from the server port table according to an external-to-internal packet of a connection between an external network and the set of server IP and server port of the internal network; performing NAPT of the external-to-internal packet according to the corresponding set of server IP and server port; selecting a first storage element from the translation table according to an internal-to-external packet of the connection; and performing NAPT of the internal-to-external packet according to the first storage element.

### BRIEF DESCRIPTION OF THE DRAWINGS

FIG. 1 is a diagram showing that nodes with private IPs in an internal network connect to an external network via a NAT/NAPT-enabled router.

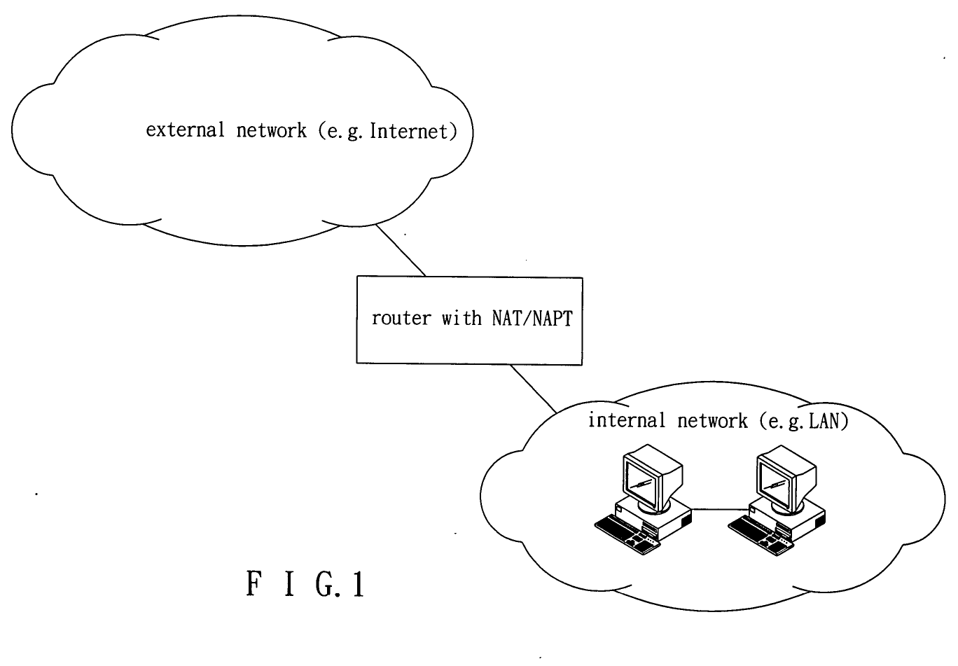

FIG. 2 is a block diagram of a preferred embodiment of the NAPT apparatus according to the present invention.

FIG. 3 is a block diagram showing a format of the translation table of FIG. 2 according to the present invention.

FIG. 4 is a flow chart of processing an external-to-internal packet according to a preferred embodiment of the NAPT method of the present invention.

FIG. 5 is a flow chart of processing an internal-to-external packet according to a preferred embodiment of the NAPT method of the present invention.

### DETAILED DESCRIPTION OF THE PRESENT INVENTION

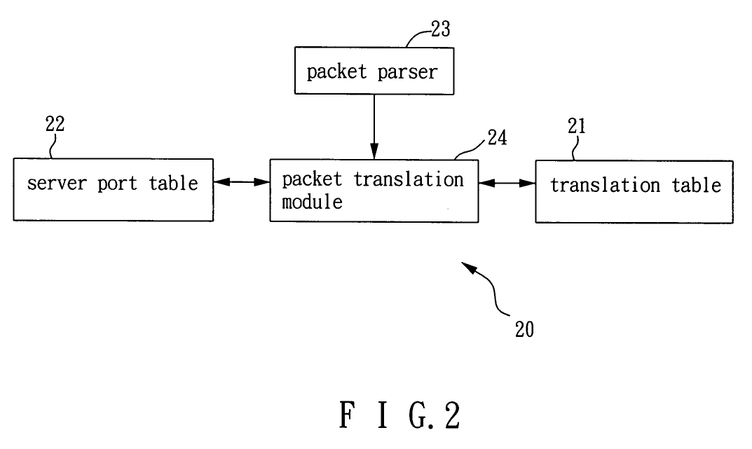

FIG. 2 is a block diagram of a preferred embodiment of the NAPT apparatus according to the present invention. The NAPT apparatus 20 lies between an external network and an internal network where internal IPs (and internal ports) are used, and performs NAPT for a NAPT connection between the external network and an opened server port of the internal network by hardware directly. As shown in FIG. 2, the NAPT apparatus 20 comprises: a server port table 22 for storing a correspondence between each opened set of server IP and server port of the internal network and at least a set of external IP and external port; a translation table 21 for storing information required for performing NAPT for a plurality of NAPT connections; a packet parser 23 for receiving packets of the NAPT connections and parsing contents of the packets; and a packet translation module 24, coupled to the server port table 22, the translation table 21 and the packet parser 23, for performing NAPT for the NAPT connections.

In the server port table 22, the opened server IPs and server ports are matched to available external IPs and external ports (e.g. obtained from ISPs) in advance, and then the NAPT apparatus 20 can utilize the server port table 22 to perform NAPT. In one embodiment, the server port table 22 is implemented by a cache memory, and each entry thereof stores a set of server IP and server port and a corresponding set of external IP and external port.

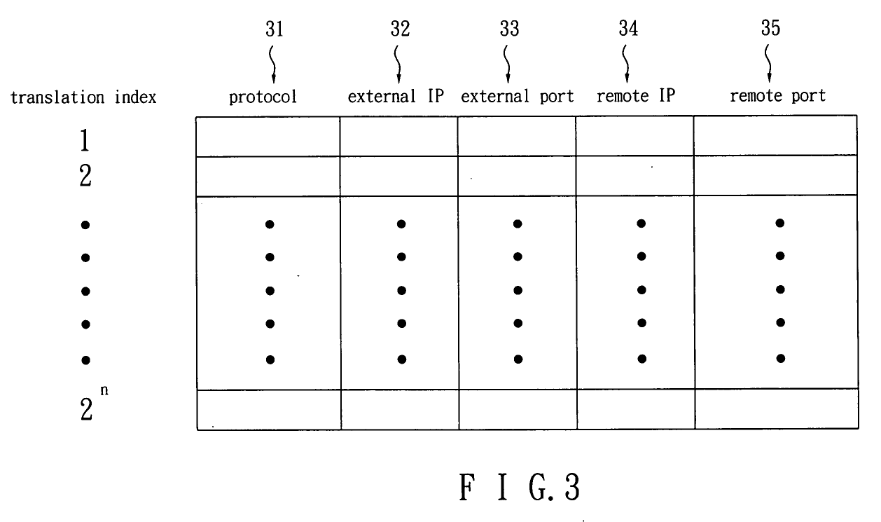

FIG. 3 is a block diagram showing a format of the translation table 21 according to the present invention. As shown in FIG. 3, the translation table 21 is a cache memory with 2ⁿ entries, wherein n is a positive integer. Each entry corresponds to an n-bit translation index and stores required information for performing NAPT for a NAPT connection. Each entry contains fields of protocol 31, external IP 32, external port 33, remote IP 34, and remote port 35. These fields are described below:

Protocol 31: used to indicate the protocol that the NAPT connection uses, such as TCP or UDP.

External IP 32: used to record the destination IP (before translation) of an external-to-internal packet of the NAPT connection (i.e. the source IP (after translation) of an internal-to-external packet of the NAPT connection). An external IP comprises 32 bits according to the current IP version.

External port 33: 16 bits long, used to record the destination port (before translation) of an external-to-internal packet of the NAPT connection (i.e. the source port (after translation) of an internal-to-external packet of the NAPT connection). Here the external port refers generally to the port number field defined in TCP or UDP.

Remote IP 34: used to record the source IP of an external-to-internal packet of the NAPT connection (i.e. the destination IP of an internal-to-external packet of the NAPT connection). A remote IP comprises 32 bits according to the current IP version.

Remote port 35: 16 bits long, used to record the source port of an external-to-internal packet of the NAPT connection (i.e. the destination port of an internal-to-external packet of the NAPT connection). Here the remote port refers generally to the port number field defined in TCP or UDP.

It is well known to one skilled in the art that the type of cache memory used to implement the translation table 21 and the server port table 22, such as a direct-mapped cache, a fully associative cache, or a multiway set-associative cache, is unlimited and also irrelevant to the objects of the present invention.

In one embodiment, if the NAPT apparatus 20 receives an external-to-internal packet, the packet parser 23 first analyzes the packet to obtain its protocol, source IP, source port, destination IP, and destination port, and then the packet translation module 24 uses the obtained destination IP and destination port to search the server port table 22, thereby determining whether there is a set of server IP and server port corresponding thereto. If the determining result is negative, it means that the external-to-internal packet does not belong to any NAPT connection connected to an opened set of server IP and port of the internal network. Thus, the packet must be dropped or forwarded to a CPU for subsequent processing. If the determining result is positive, it means that there is a node in the external network trying to make a NAPT connection with the corresponding set of server IP and server port. At this time, on one hand, the packet translation module 24 performs NAPT of the external-to-internal packet, i.e. translates the destination IP and port of the packet into the corresponding set of server IP and port respectively. On the other hand, the packet translation module 24 inputs the protocol, source IP and port, and translated destination IP and port of the external-to-internal packet into a hash function to obtain a translation index (denoted as first translation index), thereby selecting a corresponding first storage element from the translation table 21. Then, the packet translation module 24 stores the protocol, destination IP and port (before translation), and source IP and port of the external-to-internal packet into the fields of protocol 31, external IP 32, external port 33, remote IP 34, and remote port 35 of the first storage element respectively. In another embodiment, in order to save the space of the translation table 21, each storage element omits the fields of remote IP 34 and remote port 35, and then the protocol, destination IP and port (before translation) of the external-to-internal packet are stored into the fields of protocol 31, external IP 32 and external port 33 of the first storage element respectively.

It is notable that the translation indexes generated by a hash function can be distributed randomly among different packets such that the entries of the translation table 21 can be used averagely. However, the type of the hash function is unlimited, and thus MD5, CRC, XOR, or any other hash algorithm can be used in the present invention. In fact, which algorithm is used to generate the translation indexes does not limit the scope of the present invention.

In another aspect, if the NAPT apparatus 20 receives an internal-to-external packet, the packet parser 23 first analyzes the packet to obtain its protocol, source IP, source port, destination IP, and destination port, and then the packet translation module 24 inputs the protocol, source IP and port, and destination IP and port of the internal-to-external packet into the same hash function as above to obtain a translation index, thereby selecting a corresponding storage element from the translation table 21. If the obtained translation index is equal to the first translation index mentioned above, then the first storage element is selected. Next, the packet translation module 24 compares the destination IP and port of the internal-to-external packet with the remote IP 34 and port 35 of the first storage element respectively. If not equal, it means that the internal-to-external packet does not belong to an existing NAPT connection, and the packet must be dropped or delivered to a CPU for subsequent processing. If equal, then it means the internal-to-external packet belongs to an existing NAPT connection. At this time, the packet translation module 24 performs NAPT of the internal-to-external packet, i.e. translates the source IP and port of the packet into the external IP 32 and port 33 of the first storage element respectively. In the above embodiment which omits the fields of remote IP 34 and port 35 of the translation table 21, for an internal-to-external packet, as long as the translation index generated by the hash function is the first translation index, the external IP 32 and port 33 of the first storage element are directly used to perform NAPT of the internal-to-external packet without need to make the above comparison.

In all the above embodiments, the translation table 21, server port table 22, packet parser 23, and the packet translation module 24 in FIG. 2 are implemented with hardware circuits (e.g. implemented in an ASIC) to speed up the NAPT function.

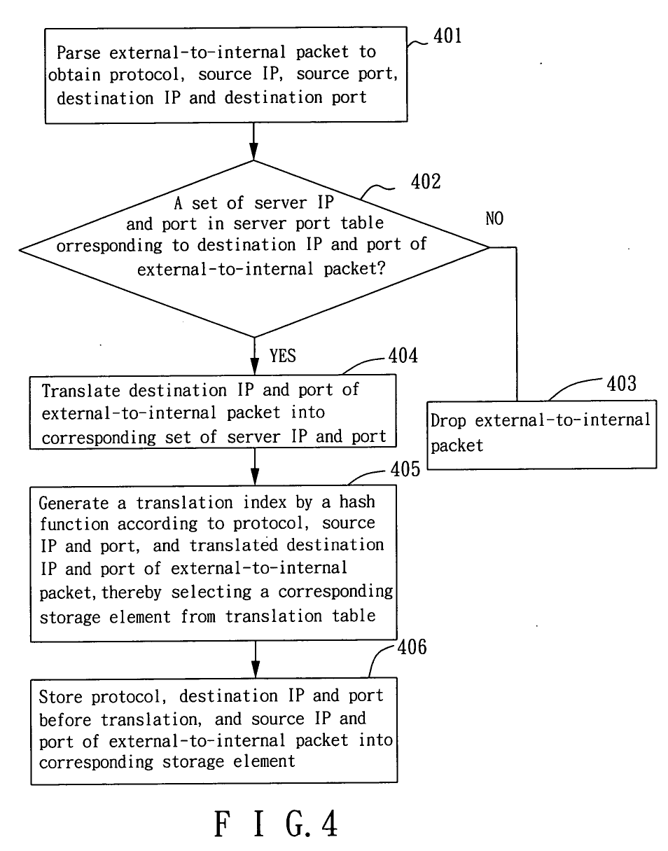

FIG. 4 is a flow chart of processing an external-to-internal packet according to a preferred embodiment of the NAPT method of the present invention. As shown in FIG. 4, the flow comprises the steps of:
401 parsing the external-to-internal packet to obtain its protocol, source IP, source port, destination IP, and destination port;
402 determining whether there is a set of server IP and server port in the server port table 22 corresponding to the destination IP and port of the external-to-internal packet, if yes then jumping to the step 404; otherwise proceeding to step 403;
403 dropping the external-to-internal packet and completing the flow;
404 translating the destination IP and port of the external-to-internal packet into the corresponding set of server IP and port;
405 generating a translation index by a hash function according to the protocol, source IP and port, and translated destination IP and port of the external-to-internal packet, thereby selecting a corresponding storage element from the translation table 21; and
406 storing the protocol, destination IP and port before translation, and source IP and port of the external-to-internal packet into the corresponding storage element.

If the result of step 402 is negative, the external-to-internal packet is dropped (step 403). If the result of step 402 is positive, it means that a node in the external network is trying to make a NAPT connection with the set of server IP and port opened by the internal network. Therefore, NAPT of the external-to-internal packet is performed (step 404). Then, the first storage element is selected from the translation table 21 by using the hash function (step 405), and the information required for performing NAPT of subsequent internal-to-external packets of the NAPT connection is stored therein (step 406). The hash function used is not limited, as described above.

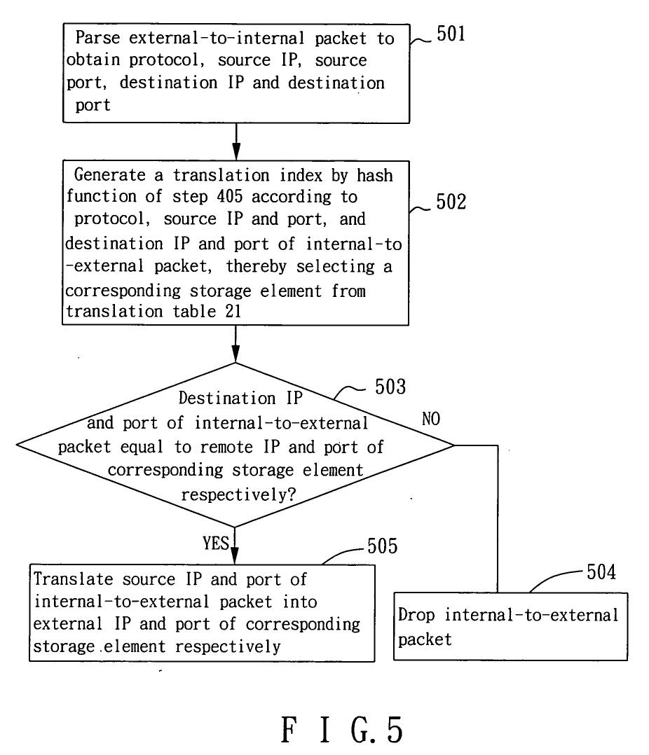

FIG. 5 is a flow chart of processing an internal-to-external packet according to a preferred embodiment of the NAPT method of the present invention. As shown in FIG. 5, the flow comprises the steps of:
501 parsing the internal-to-external packet to obtain its protocol, source IP, source port, destination IP, and destination port;
502 generating a translation index by the hash function of step 405 according to the protocol, source IP and port, and destination IP and port of the internal-to-external packet, thereby selecting a corresponding storage element from the translation table 21;
503 determining whether the destination IP and port of the internal-to-external packet are equal to the remote IP 34 and port 35 stored in the corresponding storage element respectively, if yes then jumping to step 505; otherwise proceeding to step 504;
504 dropping the internal-to-external packet and completing the flow; and
505 translating the source IP and port of the internal-to-external packet into the external IP 32 and port 33 stored in the corresponding storage element respectively.

The same hash function of step 405 is used to select the corresponding storage element from the translation table 21 according to the internal-to-external packet (step 502). Next, if the result of step 503 is positive, it means that the internal-to-external packet belongs to an existing NAPT connection, and NAPT is then performed for the internal-to-external packet (step 505). If the result of step 503 is not positive, the internal-to-external packet is dropped (step 504).

Both the flows in FIG. 4 and FIG. 5 are directly performed by hardware.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

1. An apparatus having a network address-port translation (NAPT) function comprising:
a server port table for storing at least a set of server IP and server port of an internal network, and at least a corresponding set of external IP and external port;
a translation table comprising a plurality of storage elements, wherein each of the storage elements stores a set of external IP and external port; and
a packet translation module, coupled to the server port table and the translation table, for performing NAPT for a connection between an external network and the internal network;
wherein the packet translation module selects a corresponding set of server IP and server port from the server port table according to an external-to-internal packet, thereby performing NAPT of the external-to-internal packet;
wherein the packet translation module selects a first storage element from the translation table according to an internal-to-external packet, thereby performing NAPT of the internal-to-external packet.

2. The apparatus of claim 1, wherein the NAPT function is directly performed by the packet translation module.

3. The apparatus of claim 1, wherein the packet translation module translates a destination IP and a destination port of the external-to-internal packet into the corresponding set of server IP and server port respectively when performing NAPT of the external-to-internal packet.

4. The apparatus of claim 1, wherein the packet translation module translates a source IP and a source port of the internal-to-external packet into the set of external IP and external port stored in the first storage element when performing NAPT of the internal-to-external packet.

5. The apparatus of claim 1, wherein the packet translation module selects the corresponding set of server IP and server port according to a destination IP and a destination port of the external-to-internal packet.

6. The apparatus of claim 1, wherein each of the storage elements corresponds to a translation index, wherein the first storage element corresponds to a first translation index.

7. The apparatus of claim 6, wherein the packet translation module generates the first translation index according to a source IP, a source port, a destination IP, a destination port and a protocol of the internal-to-external packet, thereby selecting the corresponding first storage element.

8. The apparatus of claim 1, wherein each of the storage elements further stores a set of remote IP and remote port.

9. The apparatus of claim 8, wherein the packet translation module performs NAPT of the internal-to-external packet when determining that a destination IP and a destination port of the internal-to-external packet correspond with the set of remote IP and remote port stored in the first storage element.

10. The apparatus of claim 1, further comprising a packet parser, coupled to the packet translation module, for parsing content of packets of the connection.

11. A method for performing network address-port translation (NAPT) by means of a server port table and a translation table, wherein the server port table stores at least a set of server IP and server port of an internal network and at least a corresponding set of external IP and external port, and the translation table comprises a plurality of storage elements, each of which stores a set of external IP and external port, the method comprising the steps of:
selecting a corresponding set of server IP and server port from the server port table according to an external-to-internal packet of a connection between an external network and the set of server IP and server port of the internal network;
performing NAPT of the external-to-internal packet according to the corresponding set of server IP and server port;
selecting a first storage element from the translation table according to an internal-to-external packet of the connection; and
performing NAPT of the internal-to-external packet according to the first storage element.

12. The method of claim 11, wherein NAPT is performed by hardware directly.

13. The method of claim 11, wherein NAPT of the external-to-internal packet is performed by translating a destination IP and a destination port of the external-to-internal packet into the corresponding set of server IP and server port respectively.

14. The method of claim 11, wherein NAPT of the internal-to-external packet is performed by translating a source IP and a source port of the internal-to-external packet into the set of external IP and external port stored in the first storage element.

15. The method of claim 11, wherein the corresponding set of server IP and server port is selected according to a destination IP and a destination port of the external-to-internal packet.

16. The method of claim 11, wherein each of the storage elements corresponds to a translation index, wherein the first storage element corresponds to a first translation index.

17. The method of claim 16, wherein the step of selecting the first storage element comprises generating the first translation index according to a source IP, a source port, a destination IP, a destination port and a protocol of the packet.

18. The method of claim 17, wherein the first translation index is generated by inputting the source IP, source port, destination IP, destination port, and protocol of the internal-to-external packet into a hash function.

19. The method of claim 11, wherein each of the storage elements further stores a set of remote IP and remote port, the method further comprises the step of:
determining whether a destination IP and a destination port of the internal-to-external packet correspond with the set of remote IP and remote port stored in the first storage element.

20. An apparatus having a network address-port translation (NAPT) function comprising:
a server port table for storing at least a set of server IP and server port of an internal network, and at least a corresponding set of external IP and external port;
a translation table comprising a plurality of storage elements, wherein each of the storage elements stores a set of external IP and external port; and
a packet translation module, coupled to the server port table and the translation table, for performing NAPT for a connection between an external network and the internal network;
wherein the NAPT function of the apparatus is directly performed by the packet translation module.

21. The apparatus of claim 20, wherein the packet translation module selects a corresponding set of server IP and server port from the server port table according to an external-to-internal packet, thereby performing NAPT of the external-to-internal packet;

22. The apparatus of claim 20, wherein the packet translation module selects a first storage element from the translation table according to an internal-to-external packet, thereby performing NAPT of the internal-to-external packet.
